(19) United States
(12) Patent Application Publication
(10) Pub. No.: US 2026/0044801 A1
(43) Pub. Date: Feb. 12, 2026

(54) Autonomous Vehicle Fleet Management System for Passenger Transportation

(71) Applicant: Vincent Loccisano, Wellesley, MA (US)

(72) Inventor: Vincent Loccisano, Wellesley, MA (US)

(21) Appl. No.: 19/361,173

(22) Filed: Oct. 17, 2025

(51) Int. Cl. G06Q 10/0631; G01C 21/34; G01C 21/36; G06Q 10/02; G06Q 30/0202; G06Q 30/0207; G06Q 30/0283; G06Q 50/43; H04W 4/44

(52) U.S. Cl. CPC G06Q 10/06315; G01C 21/3492; G01C 21/3679; G06Q 10/0283; G06Q 30/0202; G06Q 30/0207; G06Q 30/0284; G06Q 50/43; H04W 4/44

(57) ABSTRACT

An autonomous vehicle fleet-management system for passenger transportation uses autonomous vehicles and a congestion-pricing model that adjusts passenger fares according to real-time traffic conditions and demand levels. An optimized autonomous vehicle (AV) system is a hybrid fleet structure that is designed for efficient passenger transport and maintains a dynamic vehicle fleet that combines factory-owned, self-driving vehicles with privately owned, rental, and dealership vehicles (some of which may be retrofitted with autonomous capabilities, or factory-equipped with autonomous capabilities) to handle peak demand. AI-driven analytics proactively position vehicles. While diverse vehicle technologies are supported, a single-manufacturer approach is preferred for streamlined operations. The system integrates electric vehicles (EVs) with renewable-energy charging hubs, and incentivizes private EV participation. Safety and efficiency are enhanced through Vehicle-to-Infrastructure (V2I) communication, remote software updates, and potential congestion pricing. A user interface offers personalized ride options and real-time tracking while adhering to strict data-privacy standards.

### FIELD OF THE INVENTION

The present invention relates to transportation systems, specifically to methods and systems for optimizing passenger trips using autonomous vehicles through fleet management and customer-owned vehicle integration.

### BACKGROUND OF THE INVENTION

Autonomous vehicle technology has progressed to offering efficient and reliable ride-hailing services in pilot cities across the United States. These services currently rely on a single source of vehicles, which limits flexibility and responsiveness to fluctuating demand. For instance, these fleets are extensive enough to meet peak demand at certain times of the day or evening, but may sit idle in downtime. Or these services might lack sufficient fleets and system architectures to meet peak demand periods, resulting in longer wait times and increased costs for passengers. An optimized method that manages both a fleet of autonomous vehicles and customer-owned autonomous vehicles would improve passenger transportation services while providing efficient vehicle servicing and maintenance.

### SUMMARY

An autonomous vehicle fleet-management system for passenger transportation uses autonomous vehicles and a congestion-pricing model that adjusts passenger fares according to real-time traffic conditions and demand levels. An optimized autonomous vehicle (AV) system is a hybrid fleet structure that is designed for efficient passenger transport and maintains a dynamic vehicle fleet that combines factory-owned, self-driving vehicles with privately owned, rental, and dealership vehicles (some of which may be retrofitted with autonomous capabilities, or factory-equipped with autonomous capabilities) to handle peak demand. AI-driven analytics proactively position vehicles. While diverse vehicle technologies are supported, a single-manufacturer approach is preferred for streamlined operations. The system integrates electric vehicles (EVs) with renewable-energy charging hubs, and incentivizes private EV participation. Safety and efficiency are enhanced through Vehicle-to-Infrastructure (V2I) communication, remote software updates, and potential congestion pricing. A user interface offers personalized ride options and real-time tracking while adhering to strict data-privacy standards.

A primary fleet comprises autonomous vehicles with factory-installed, self-driving capabilities. The size of this fleet is optimized to serve a consistent baseload demand of a defined geographic region. Although not required, the primary fleet of vehicles may be sourced from a single manufacturer to ensure consistency. A supplemental fleet of autonomous vehicles is dispatched to handle periods of high or peak demand. This fleet may comprise privately owned vehicles, rental vehicles or dealership vehicles that are equipped with approved self-driving technology.

A secondary fleet is stocked by responding to peak load demand. The system and method dynamically sets and revises the number of vehicle numbers in this fleet.

A central management system serves as the operational core, and communicates with all vehicles in the fleet. The key functions of the central-management system include AI-driven demand prediction, strategic vehicle positioning, and dynamic fleet scaling. AI-driven demand prediction uses artificial intelligence and analytics to predict passenger demand patterns across the operational area. Using these predictions, the system receives trip requests and positions vehicles to minimize passenger wait times.

The system dynamically activates vehicles from the supplemental fleet during predicted or actual periods of high demand, and deactivates them when demand subsides. This allows the active fleet size to scale elastically with demand.

By activating autonomous capabilities of the vehicles such as the sensor suite (which includes cameras, ultrasonic sensors, LiDAR, RADAR, etc.) the central management system dynamically scales the active portion of the fleet by activating vehicles from the supplemental fleet of autonomous vehicles during periods of high demand, and deactivates the second set of autonomous vehicles during periods of low demand.

Incentive programs encourage owners of private vehicles to participate in the supplemental fleet. Such incentives may include free charging at network stations, direct financial reimbursement for the use of the vehicle or a reduction in the owner's vehicle lease or finance payments.

The central management system verifies that the sensor suite, processing units and actuators of each peak-load vehicle are operational, and that environmental conditions are suitable for autonomous driving before the vehicles are dispatched.

In some embodiments, vehicle-to-infrastructure (V2I) communication is employed to communicate with traffic infrastructure, such as traffic signals and road sensors, to receive real-time traffic updates for route optimization. Strategically located operational hubs are designed for vehicle maintenance, charging and cleaning. A congestion-pricing model dynamically adjusts fares according to real-time traffic conditions and passenger demand. The central system integrates various management functions, including vehicle dispatch, maintenance scheduling and passenger service.

In some embodiments, passengers interact with the service through a user interface that enables ride/trip customization, and provides real-time updates on vehicle status and predicted journey durations. Passengers may select at least one of a vehicle type, vehicle amenities or preferred routes. The system ensures data privacy through the encryption of passenger data and secure storage protocols.

The system operates in defined geographic zones, using strategically placed hubs to manage vehicle maintenance, charging and storage, minimizing empty trips. The active fleet size adjusts dynamically to demand, sourcing additional vehicles when needed and returning them to depots during lulls. Pilot programs and partnerships facilitate rollout and integration with existing transport networks. In practice, users request rides via an app; an AV is dispatched, and the journey is monitored remotely. This comprehensive approach integrates functionalities typically handled separately by manufacturers, ride-sharing companies, and logistics providers.

### DESCRIPTION

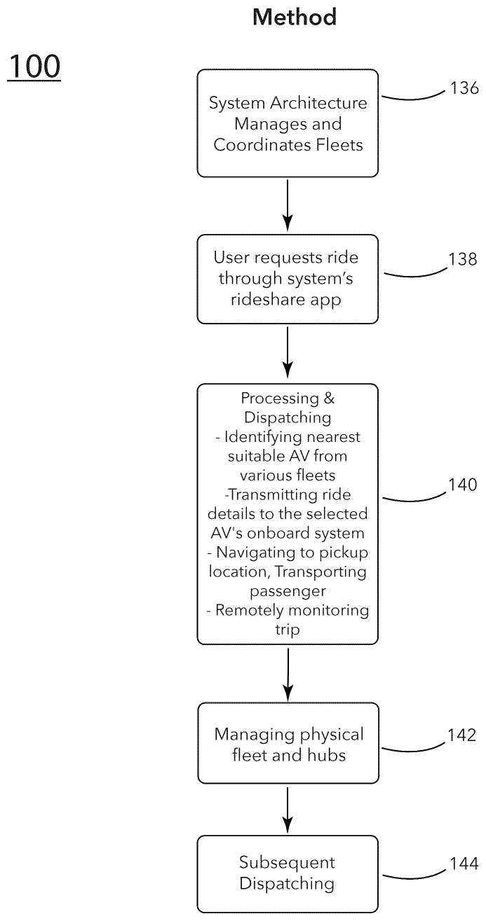

FIG. 1 is a flowchart of the system and method.

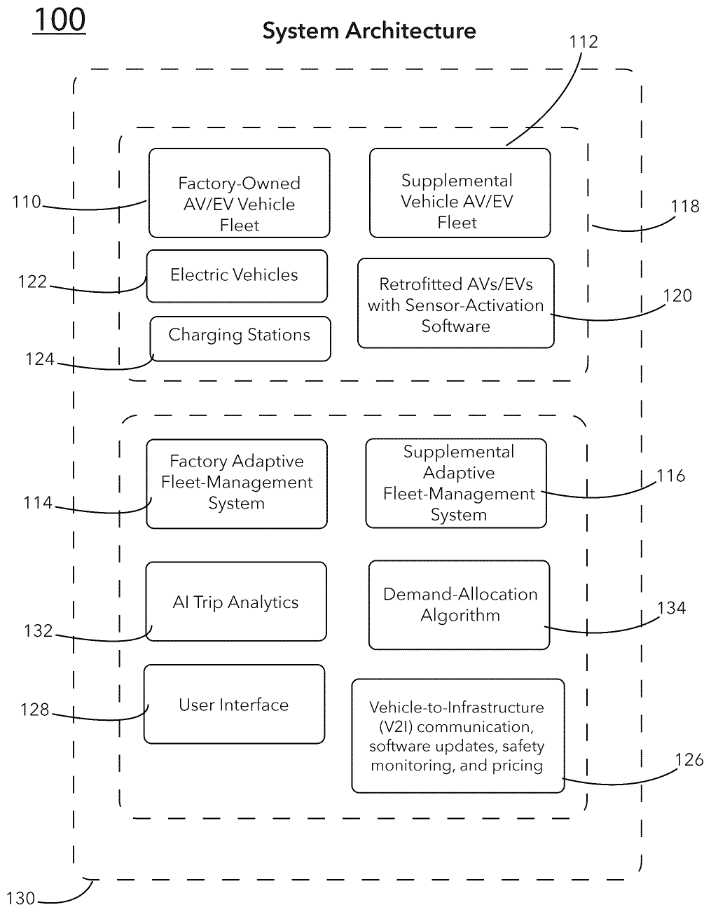

FIG. 2 is a graphical representation of the system architecture.

### DETAILED DESCRIPTION

An optimized system 100 efficiently serves passenger trips by managing a dynamic autonomous vehicle fleet. This includes factory-owned vehicles 110 with full self-driving capabilities for base-load capacity, supplemented by a secondary fleet of privately-owned, rental, and dealership vehicles (also equipped with a self-driving technology, retrofitted or onboard) 112 to meet peak demand. Adaptive fleet management 114, 116, using AI-driven analytics 132, predicts high-demand zones and proactively positions vehicles to minimize wait times. While the system can integrate diverse vehicle technologies from multiple manufacturers, a preferred embodiment sources vehicles from a single manufacturer (e.g., Tesla) 110. This simplifies rollout and ensures uniformity in technology, maintenance, and operations protocols Vehicles in the fleet 118 operate either with native, factory-installed autonomy or via retrofitted self-driving technology. This integration enables the system to respond to passenger demand at designated locations. Additional vehicles, often privately owned, are equipped with sensor suites that can be activated on demand 120. Before autonomous operation, the vehicle's central computer verifies its sensors (LiDAR, radar, cameras, etc.), processing units, and actuators, ensuring all systems are operational and environmental conditions are safe. Examples of aftermarket autonomous packages include Comma. ai and Motional; such driverless systems can provide autonomous ride-hail and delivery services.

The system and method integrates electric vehicles (EVs) 122 into its fleet. Charging stations 124 are equipped with renewable energy sources, such as solar panels, to reduce carbon footprint. The system encourages the use of EVs by offering incentives for individually owned electric vehicles participating in the network. The charging network expands by inviting additional stations in the operational boundary to participate. These additional stations may include private, public or municipal locations.

For safety and efficiency, the system uses Vehicle-to-Infrastructure (V2I) communication 126, enabling vehicles to interact with traffic signals and road sensors for real-time updates and route optimization. Autonomous driving software receives remote updates. The system may also employ a congestion-pricing model, dynamically adjusting fares based on traffic conditions and demand 134.

A user interface 128 offers personalized features like selecting vehicle type, amenities, and preferred routes, along with real-time updates on vehicle arrival and journey times. Comprehensive safety measures include continuous vehicle performance monitoring, regular maintenance, and updated emergency-response protocols. Passengers can also share trip details with trusted contacts. The system adheres to strict data-privacy standards, protecting passenger data through encryption, secure storage, and compliance with relevant data-protection regulations.

To optimize efficiency and resource allocation, the system operates within a defined geographic area 130, with a service radius around key locations. At least two strategically located hubs in high-demand areas minimize empty backhauls and facilitate efficient vehicle maintenance and turnaround, potentially using existing facilities like rental-car lots. The system's software integrates management capacities currently handled discretely by manufacturers, ride-sharing companies, or third-party logistics providers.

The active AV fleet can be dynamically scaled. During demand surges, supplemental vehicles 112 may be sourced from manufacturer stock, rental fleets, or individual owners. In low-demand periods, vehicles return to depots or holding areas to optimize operational costs and ensure efficient capital utilization.

System rollout can be facilitated by pilot programs in selected cities. The system's modular design allows for scaling and expansion into new geographic areas with additional hubs. Partnerships with local governments, public-transportation agencies, and private enterprises can aid integration with existing transport networks.

### An Example Method Includes

1. The system architecture managing and coordinating fleets 136.
2. A user requesting a ride 138 through the system's ride-sharing application; may also track vehicle availability and view pricing adjustments.
3. The dispatch system identifying the nearest suitable AV, 140 considering capacity, charge, etc.
4. Transmitting ride details to the selected AV's onboard system 140.
5. The AV navigating to the pickup location, collecting the passenger, and transporting them to the destination 140.
6. Monitoring the trip 140 with remote operations teams available to intervene if the AV encounters unresolvable situations (e.g., unexpected road closures).
7. Managing 142 physical locations and hubs for vehicle storage, EV charging, cleaning, and maintenance.
8. After a trip, dispatching 144 the AV for another ride or directing it to a depot for charging, cleaning, or maintenance based on its status and system needs. Logging trip data (mileage, sensor readings, interventions) for system improvement and preventative maintenance.

1. A system for managing passenger trips using autonomous vehicles comprising:
a fleet of autonomous vehicles including a first set of autonomous vehicles having factory-installed self-driving capabilities wherein said fleet size is selected to meet the baseload demand for a geographic region of operation; and
a second set of supplemental autonomous vehicles, wherein the size of the second set of autonomous vehicles is dynamically set based on peak load demand; and
a central management system communicatively coupled to said fleet of autonomous vehicles configured to receive trip requests; and
utilize AI-driven analytics to predict passenger demand with a defined geographic area; and
position vehicles from the fleet within the defined geographical area based on predicted passenger demand; wherein
the central management system is configured to dynamically scale the active portion of the fleet by activating vehicles from the second set of supplemental autonomous vehicles during periods of high demand, and deactivating the second set of autonomous vehicles during periods of low demand.

2. The system of claim 1 wherein the second set of supplemental autonomous vehicles comprise at least one of:
privately-owned vehicles, rental vehicles, dealer-owned vehicles; wherein each of the supplemental vehicles is equipped with a self-driving technology and are used for peak load response.

3. The system of claim 1 wherein:
a plurality of the autonomous vehicles in the fleet are electric vehicles and the system further comprises a plurality of charging stations configured to charge the electric vehicles.

4. The system of claim 1 wherein:
the central management system is further configured to offer incentives for individually owned electric vehicles to participate as part of the second set of supplemental autonomous vehicles.

5. The system of claim 1 wherein:
the central management system is further configured to receive verification from the peak load vehicle that its sensor suite, processing units and actuators are operational and that environmental conditions are suitable for autonomous driving.

6. The system of claim 1 wherein:
the autonomous vehicles and the central management system are configured for vehicle-to-infrastructure communication; wherein
the vehicles are enabled to interact with traffic signals and road sensors for real-time traffic updates and route optimization.

7. The system of claim 1 further comprising:
at least two hubs located within the defined geographic area; wherein
the hubs are configured to facilitate vehicle maintenance, charging and efficient vehicle turnaround.

8. They system of claim 1 further comprising:
a user interface, accessible by passengers and configured to allow passengers to select at least one of a vehicle type, amenities or preferred routes; and
provide passengers with real-time updates on vehicle arrival and journey time.

9. The system of claim 1 wherein:
the central management system is further configured to implement a congestion-pricing model that dynamically adjusts fares based on traffic conditions and passenger demand.

10. The system of claim 1 wherein:
the central management system is configured to integrate management capacities related to vehicle dispatch, maintenance scheduling and passenger service.

11. The system of claim 1 wherein:
the autonomous vehicles in the fleet are sourced from a single vehicle manufacturer to ensure uniformity in technology, maintenance and operation protocols.

12. The system of claim 1 wherein:
the central management system is further configured to ensure data privacy by employing encryption for passenger data and secure storage.

13. A method for managing passenger trips using a fleet of autonomous vehicles comprising:
maintaining a fleet of autonomous vehicles, said fleet including a first set of autonomous vehicles having factory-installed self-driving capabilities and a second set of supplemental autonomous vehicles; and
receiving, by way of a central management system, trip requests from users; and
predicting, through artificial intelligence-driven analytics executed by the central management system, passenger demand within a defined geographic area; and
positioning, by said central management system, vehicles from said fleet within said defined geographic area based on said predicted passenger demand to minimize passenger wait times.

14. The method of claim 13 wherein:
the second set of supplemental autonomous vehicles comprise at least one of:
retrofitted privately-owned vehicles, retrofitted rental vehicles, or retrofitted dealership vehicles; wherein
each of the supplemental vehicles are equipped with a self-driving technology package enabling autonomous operation.

15. The method of claim 13 further comprising:
dynamically scaling, by way of the central management system, the active portion of the fleet of vehicles by activating sensor suites and autonomous capabilities of vehicles from the second set of supplemental autonomous vehicles during periods of predicted high demand.

16. The method of claim 13 wherein:
a plurality of the autonomous vehicles are electric vehicles; and further comprising:
directing the electric vehicles to a plurality of charging stations for charging; and
utilizing renewable energy sources at a subset of the charging stations to charge the electric vehicles.

17. The method of claim 13 further comprising:
verifying, through the central management system, the operational status of the retrofitted vehicle's sensor suite, processing units and actuators prior to dispatching a retrofitted vehicle from the second set.

18. The method of claim 13 further comprising:
utilizing vehicle-to-infrastructure communication between the autonomous vehicles and traffic infrastructure to receive real-time traffic data; and
optimizing vehicle routes based on the real-time traffic data.

19. The method of claim 13 further comprising:
providing a user interface enabling passengers to submit personalized trip requests; and
transmitting real-time updates regarding vehicle arrival and journey progress to said passengers via said user interface.

20. The method of claim 13 further comprising:
adjusting passenger fares based on current traffic conditions and demand levels using a congestion-pricing model implemented by the central management system.
